(19) United States
(12) Patent Application Publication
(10) Pub. No.: US 2021/0407010 A1
(43) Pub. Date: Dec. 30, 2021

(54) SYSTEM AND METHOD FOR PROVIDING INVESTMENT INFORMATION

(71) Applicant: JONGTAK CHOI, Hwaseong-si (KR)

(72) Inventor: JONGTAK CHOI, Hwaseong-si (KR)

(21) Appl. No.: 17/325,744

(22) Filed: May 20, 2021

(30) Foreign Application Priority Data
Jun. 30, 2020 (KR) 10-2020-0080485

(51) Int. Cl. G06Q 40/06; G06Q 10/06; G06Q 30/02; G06F 7/08

(52) U.S. Cl. CPC G06Q 40/06; G06F 7/08; G06Q 30/0282; G06Q 10/06398

(57) ABSTRACT

According to an embodiment, a system for providing investment information comprises an asset size information acquisition unit obtaining an investment asset size of an investment analyst from an investment system, a rating unit rating an investment analyst level with respect to the investment asset size, based on the investment asset size obtained from the asset size information acquisition unit, and an information providing unit displaying and providing the investment analyst level to investment information uploaded by the investment analyst.

### CROSS-REFERENCE TO RELATED APPLICATION(S)

This application claims priority to Korean Patent Application No. 10-2020-0080485 filed in the Korean Intellectual Property Office on Jun. 30, 2020, the disclosure of which is incorporated by reference herein in its entirety.

### TECHNICAL FIELD

Embodiments of the disclosure relate to a system and method for providing investment information, and more specifically, to a system and method for providing high-quality investment information by rating investment analysts who update investment information based on information obtained from a financial sector.

### DISCUSSION OF RELATED ART

In general, it is important to obtain financial related information quickly and accurately in financial investment. Prediction of what financial products to invest in, such as stocks, bonds, deposits, foreign exchange, or insurance, what products will generate the greatest returns and what potential risks are there is of greatest concern to investors.

However, the information that ordinary investors may access for the purpose of making financial investments is very limited unless they are in the financial industry. They grasp trends or obtain investment information by read related news articles or from their friends or acquaintances. Also, they collect information through an online community or bulletin board that provides related information.

However, if based on the information gathered through such information sources, investment leads to loss because of the inaccuracy of the information.

Further, since the amount of information obtained from news articles or the Internet is vast and scattered, it is difficult for ordinary investors who lack time and experience to determine the quality of information within a limited time in a quickly varying investment environment.

In contrast, institutional investors are provided with special services from experts, such as analysts and economists to make investment decisions. However, since most ordinary investors have difficulty accessing professional services due to time or money issues, the high-class information is concentrated on a small number of individual investors and some people who work in the financial industry.

Further, even after ordinary investors construct their own investment portfolios after struggling, investment-related forecasts and decisions, such as future prospects for expected returns, forecasts for additional buying and selling times continue to occur, but since there is no investment environment that may continuously support them, the development and growth of individual investment patterns are still far away.

Thus, a need arises for an investment method using a sharing of objective social knowledge or information to allow ordinary investors to easily obtain high-class investment information, make desirable investment decisions through comparison and analysis of other investors' portfolios, and benchmark others' investment portfolios and own them as their own portfolios even when they are not engaged in financial industry or use professional services at high costs.

Meanwhile, in the Internet era, myriad investment information is being shared, but it is very difficult to identify which information is valuable. For example, severe debate on a specific topic frequently occurs among members of an investment-related service.

Even in this situation, it is very difficult for ordinary investors to identify who has wise insight and judgment.

### SUMMARY

According to an embodiment, there is provided a system and method for providing investment information, which may allow ordinary investors to accurately and quickly obtain high-quality investment information necessary for financial investment.

According to an embodiment, there is provided a system and method for providing investment information, which may promote or encourage generation of better investment information and enhance the quality of overall information by continuously monitoring investment analysts' activities and updating the investment analyst's level by reflecting the results of monitoring.

Objects of the disclosure are not limited to the foregoing, and other unmentioned objects would be apparent to one of ordinary skill in the art from the following description.

To achieve the above objectives, the disclosure includes the following components.

According to an embodiment, a system for providing investment information comprises an asset size information acquisition unit obtaining an investment asset size of an investment analyst from an investment system, a rating unit rating an investment analyst level with respect to the investment asset size, based on the investment asset size obtained from the asset size information acquisition unit, and an information providing unit displaying and providing the investment analyst level to investment information uploaded by the investment analyst.

The system may further comprise a return rate information acquisition unit obtaining return-on-investment (ROI) rate information of the investment analyst from the investment system. The rating unit may rate the investment analyst level by further reflecting the ROI rate information obtained from the return rate information acquisition unit.

The system may further comprise an evaluation information input unit receiving evaluation information from other investors for the investment information uploaded by the investment analyst. The rating unit may update the investment analyst level by reflecting the evaluation information input to the evaluation information input unit.

The rating unit may update the investment analyst level by reflecting the evaluation information periodically input to the evaluation information input unit.

The return rate information acquisition unit may obtain information for an investment amount of the investment analyst and an ROI rate for several months to several years for the investment amount. The rating unit may update the investment analyst level based on the ROI rate information obtained by the return rate information acquisition unit.

The information providing unit may receive an investment information request including the investment analyst level and filter investment information uploaded by investment analysts whose levels are equal to or higher than the investment analyst level and provide the filtered information.

According to an embodiment, a method for providing investment information, performed in an investment information providing system including an asset size information acquisition unit, a rating unit, and an information providing unit, comprises obtaining, by the asset size information acquisition unit, an investment asset size of an investment analyst from an investment system, rating, by the rating unit, an investment analyst level with respect to the investment asset size, based on the investment asset size obtained from the asset size information acquisition unit, and displaying and providing, by the information providing unit, the investment analyst level to investment information uploaded by the investment analyst according to an investment information request.

The method may further comprise obtaining, by a return rate information acquisition unit, return-on-investment (ROI) rate information of the investment analyst from the investment system. Rating the investment analyst level may include rating the investment analyst level by further reflecting the ROI rate information obtained from the return rate information acquisition unit.

The method may further comprise receiving, by an evaluation information input unit, evaluation information from other investors for the investment information uploaded by the investment analyst. Rating the investment analyst level may include updating the investment analyst level by reflecting the evaluation information input to the evaluation information input unit.

Rating the investment analyst level may include updating the investment analyst level by reflecting the evaluation information periodically input to the evaluation information input unit.

Obtaining the ROI rate information may include obtaining information for an investment amount of the investment analyst and an ROI rate for several months to several years for the investment amount. Rating the investment analyst level may include updating the investment analyst level based on the ROI rate information obtained by the return rate information acquisition unit.

Displaying and providing the investment analyst level may include receiving an investment information request including the investment analyst level and filtering investment information uploaded by investment analysts whose levels are equal to or higher than the investment analyst level and providing the filtered information. According to embodiments, there may be provided a system and method for providing investment information, which may allow ordinary investors to accurately and quickly obtain high-quality investment information necessary for financial investment.

According to embodiments, there may be provided a system and method for providing investment information, which may promote or encourage generation of better investment information and enhance the quality of overall information by continuously monitoring investment analysts' activities and updating the investment analyst's level by reflecting the results of monitoring. According to an embodiment, there is provided a system and method for providing investment information, which may promote or encourage generation of better investment information and enhance the quality of overall information by continuously monitoring investment analysts' activities and updating the investment analyst's level by reflecting the results of monitoring.

### BRIEF DESCRIPTION OF THE DRAWINGS

A more complete appreciation of the disclosure and many of the attendant aspects thereof will be readily obtained as the same becomes better understood by reference to the following detailed description when considered in connection with the accompanying drawings, wherein:

FIG. 1 is a block diagram illustrating a configuration of a system for providing investment information according to an embodiment;

FIG. 2 is a view illustrating investment analyst levels rated by a rating unit according to an embodiment; and

FIG. 3 is a flowchart illustrating a method for providing investment information according to an embodiment.

### DETAILED DESCRIPTION

The terms as used herein are provided merely to describe some embodiments thereof, but not to limit the disclosure. The terms as used herein are provided merely to describe some embodiments thereof, but not to limit the scope of other embodiments of the disclosure. Unless otherwise defined, all terms including technical and scientific terms used herein have the same meaning as commonly understood by one of ordinary skill in the art to which the embodiments of the disclosure pertain and should not be interpreted as overly broad or narrow.

Hereinafter, preferred embodiments of the disclosure are described in detail with reference to the accompanying drawings.

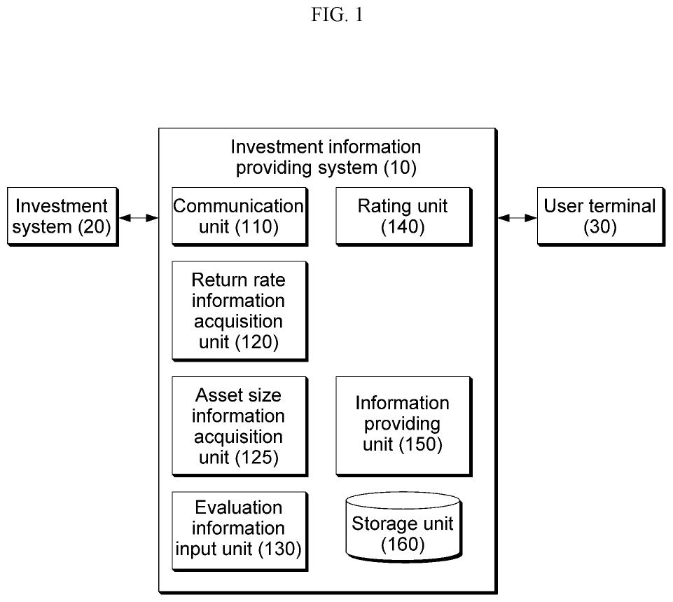

FIG. 1 is a block diagram illustrating a configuration of a system for providing investment information according to an embodiment.

According to an embodiment, a system for providing investment information (also referred to as an investment information providing system) rates initial analyst classes as ion, bronze, silver, gold, platinum, diamond, master, and grand master based on the investment amounts of members and investment returns for 1 y (one year), 3 y (three years), and 5 y (five years) obtained from securities companies, investment companies, banks, or other financial organizations so as to discover experts (middle champion) who have special knowledge, insight, or expertise on the Internet or social media.

The members may recognize their ratings and grasp, at a glance, which investment analysts are middle champions and which investment analysts are newbies, and what investment information is valuable information (e.g., investment information created by the middle champions) from the ratings of the information about the investment analysts.

The members may secondarily receive subsequent feedback (F/B) (e.g., likes/dislikes) for the investment information as evaluation information, from other investors. In determining the investment analyst classes, the fed-back evaluation scores are reflected.

For example, after one day, one month, six months, or one year, the like/dislike evaluation information regarding the investment information is counted and partially reflected in determining the investment classes.

Accordingly, middle champions with insight are induced or encouraged to provide high-quality investment information.

In other words, according to an embodiment, the investment information providing system 10 may help easily obtaining high-class information by rating and classifying investment classes based on the total investment amount+investment returns of the investment analysts and allowing ordinary users (or ordinary investors) to identify the class of the investment analyst who uploads investment information.

Referring to FIG. 1, according to an embodiment, the investment information providing system 10 includes a communication unit 110, a return rate information acquisition unit 120, an asset size information acquisition unit 125, an evaluation information input unit 130, a rating unit 140, an information providing unit 150, and a storage unit 160.

The communication schemes supported by the communication unit 110 are not limited, and the communication unit 110 may perform data transmission/reception in a communication scheme using a network (e.g., a mobile communication network, wired Internet, wireless Internet, or broadcasting network) or in a short-range wireless communication scheme.

The network may include at least one of a personal area network (PAN), a local area network (LAN), a campus area network (CAN), a metropolitan area network (MAN), a wide area network (WAN), a broadband network (BBN), or the Internet.

The network may include, but is not limited to, at least one network topology including a bus network, a star network, a ring network, a mesh network, a star-bus network, or a tree or hierarchical network.

In an embodiment, the communication unit 110 communicates with an investment system 20 and a user terminal 30.

The investment system 20 includes a server of a securities company. The investment system 20 is interpreted to encompass all kinds of financial industry companies, such as securities firms, investment companies, and banks, and is interpreted to encompass all kinds of service providing servers that provide financial services structured to make a profit from investment by investors.

According to an embodiment, the user terminal 30 may be applicable to various terminals or devices, such as smartphones, portable terminals, mobile terminals, foldable terminals, personal digital assistants (PDAs), portable multimedia players (PMPs), telematics terminals, navigation terminals, personal computers, laptop computers, slate PCs, tablet PCs, Ultrabook computers, wearable devices, such as smartwatches, smart glasses, head-mounted displays, etc., Wibro terminals, Internet protocol television (IPTV) terminals, smart TVs, digital broadcast terminals, audio video navigation (AVN) terminals, audio/video (NV) systems, flexible terminals, or digital signage devices.

In one embodiment, the user terminal 30 is carried by the investor, and a dedicated app for providing investment information may be installed and run on the user terminal 30. The user terminal 30 may also run programs or apps provided by various service platforms, such as YouTube or blogs or community websites. According to an embodiment, the investment information providing service may be implemented through various service platforms.

The return rate information acquisition unit 120 obtains information regarding the return on investment (ROI) information for investment analysts from the investment system 20 including a financial server, such as a securities company server and a bank server, for example.

In an embodiment, the return rate information acquisition unit 120 may include or obtain the names, photos, and dates of signing up the system of the investment analysts. The return rate information acquisition unit 120 may include or obtain various information related to other investment analysts following a corresponding investment analyst, the number of the other investment analysts, other investment analysts followed by an investment analyst and the number of the other investment analysts.

The asset size information acquisition unit 125 may obtain various pieces of investment asset size information and investment information, such as information regarding the total amount of assets of the investment analysts, the investment items and the amount of assets invested in each item. The asset size information acquisition unit 125 may also obtain various pieces of return rate-related information, such as the return rate of each investment portfolio proposed by the investment analysts and the overall return rate of the investment portfolios.

However, without limitations thereto, the asset size information acquisition unit 125 may comprehensively obtain a diversity of information by which the investment analysts may identify the size of investment assets and the corresponding return rate information through various financial investment systems.

The rating unit 140 rates or grades the levels of the investment analysts based on the return on investment information obtained by the return rate information acquisition unit 120.

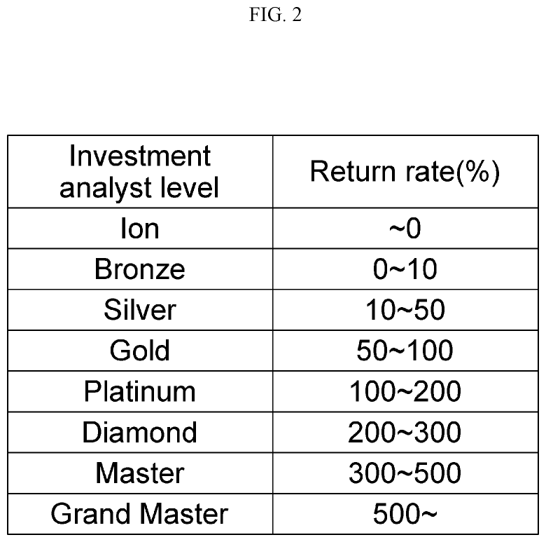

FIG. 2 is a view illustrating investment analyst levels rated by a rating unit according to an embodiment.

As an example, the rating unit 140 divides the levels of investment analysts into ion, bronze, silver, gold, platinum, diamond, master, and grand master depending on the return-on-investment rates as illustrated in FIG. 2.

According to an embodiment, the return rate information acquisition unit 120 obtains information regarding the amount of funds invested by the members and the ROI rates for several months to several years, and the rating unit 140 updates the levels of the investment analysts based on the ROI rate information obtained from the return rate information acquisition unit 120.

For example, the rating unit 140 may obtain the investment amounts of the investment analysts and the ROI rates in units of 1-year, 3-year, and 5-year return rates and assign ratings based on the return rates obtained by the investment system 20.

Various changes or modifications may be made to the names and number of the ratings and a return rate reference for each rating.

According to an embodiment, the evaluation information input unit 130 secondarily receives evaluation information from other investors for the investment information uploaded by the investment analysts. For example, the evaluation information input unit 130 receives inputs of the like/dislike selection buttons from investors who have read the investment information of the investment analysts and counts the ‘like’ and ‘dislike’ inputs, respectively.

The rating unit 140 may determine the levels of the investment analysts by further reflecting the evaluation information input to the evaluation information input unit 130 in addition to the return rates of the investment analysts.

The rating unit 140 updates the levels of the investment analysts by reflecting the evaluation information periodically input to the evaluation information input unit 130. For example, the rating unit 140 counts the ‘like’ and ‘dislike’ inputs periodically in units of predetermined periods, e.g., after 2 days, 1 month, 6 months, and 1 year.

Accordingly, it is possible to continuously reflect the investment analysts' investment information evaluations by other investors. In other words, as the levels of the investment analysts are periodically updated, the evaluation on the investment analysis is maintained as the levels of the investment analysts, or if the evaluation by other investors gets worse over time, the levels may be lowered while the levels may be raised if the evaluation by other investors gets better. In this case, a rise of the level may occur when a predetermined number of ‘likes’ or more are received, and a fall of the level may occur when a predetermined number of ‘dislikes’ or more are received.

By periodically changing the levels of the investment analysts, the system of assessing the investment analyst levels may be more reliable.

In other words, it is possible to encourage generation of high-quality investment information and enhance the overall quality of information by continuously monitoring the investment analysis activities of the investment analysts and updating the levels of the investment analysts by reflecting the results of monitoring.

The information providing unit 150 displays and provides the levels of the investment analysts, which have been rated or graded according to the ROI rate information by the rating unit 140, to the investment information uploaded by the investment analysts according to a request for investment information from the user terminal 30 carried by the investor.

According to an embodiment, the information providing unit 150 receives a request for investment information including an investment analyst level from the user terminal 30 and filters and provides the investment information uploaded from investment analysts with the investment analyst level or higher level. In other words, an investor may obtain only filtered investment information provided from the investment analysts whose levels are the investment analyst level or higher.

According to an embodiment, the information providing unit 150 may provide the investment information requested by the investor carrying the user terminal 30 to the user terminal 30 through the communication unit 110.

The storage unit 160 may include at least one type of storage medium of flash memory types, hard disk types, multimedia card micro types, card types of memories (e.g., SD or XD memory cards), RAMs (Random Access Memories), SRAMs (Static Random Access Memories), ROMs (Read-Only Memories), EEPROMs (Electrically Erasable Programmable Read-Only Memories), PROMs (Programmable Read-Only Memories), magnetic memories, magnetic disks, or optical discs.

According to an embodiment, the storage unit 160 stores data and program(s) necessary to apply a return rate-based investment level to the investment analyst who has uploaded analysis information and display and provide the investment analyst's investment level to the analysis information uploaded by the investment analyst.

Specifically, the storage unit 160 may store information for investment analysts, return rate information for the investment analysts, and investment level information for the investment analysts.

According to an embodiment, a reference for assigning ratings by the rating unit 140 is not uniformly applied to all investors.

For example, for investors who value a short-term return rate, the rating unit 140 may assign a weight of 0.8 to the return rate for 0 to 1 month and a weight of 0.2 to the return rate for 1 month to 2 years so that the investment analyst level is determined with a more weight put on the short-term return rate.

In contrast, for investors who value a long-term return rate, the rating unit 140 sets the weight for 0 to 1 month return rate to 0.1 and the weight for 1 month to 2 year return rate to 0.2. Further, the rating unit 140 may set the weight for return rate for 5 years or longer to 0.5.

Thus, a reference for rating may be set so that a higher investment analyst level is assigned to the investment analyst who produces a higher ROI rate on the items preferred by the investor or the investment analyst who produces a higher RO rate according to the investment style preferred by the investor.

According to an embodiment, the information providing unit 150 may gather the posts or comments uploaded on the web or social media by the investment analyst whose level is the investment analyst level by web crawling and provide the same. The information providing unit 150 may also provide link information which may lead to the blog, homepage, or social media of the investor analyst's account.

In other words, the information providing unit 150 may obtained data posted on the web by the investment analyst, but without limitations to the investment analysis information provided from the investment analyst through the investment analyst providing system 10.

In this case, it may be required that the investment analyst first agree to share predetermined personal information, investment analysis content, and investment analysis level.

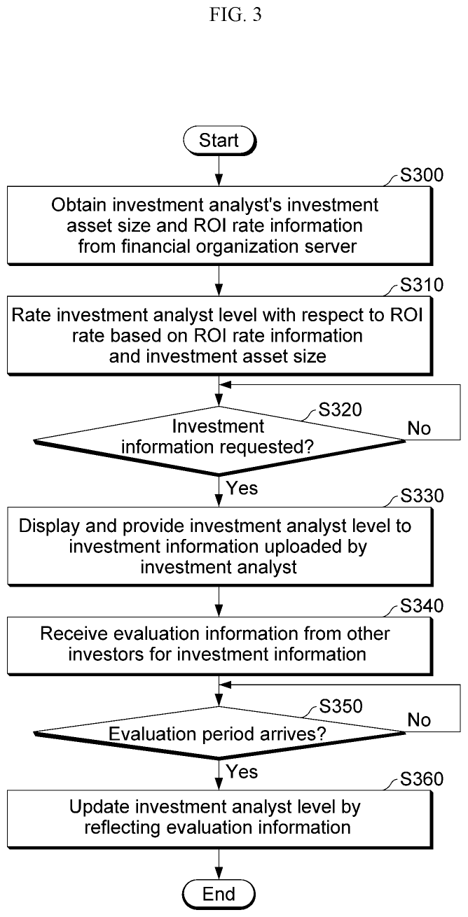

FIG. 3 is a flowchart illustrating a method for providing investment information according to an embodiment.

In a method for providing investment information, performed in an investment information providing system including a return rate information acquisition unit, a rating unit, and an information providing unit, an asset size information acquisition unit obtains investment asset size information for an investor analyst, and the return rate information acquisition unit obtains ROI rate information from an investment system (S300).

In an embodiment, the return rate information acquisition unit may include or obtain the names, photos, and dates of signing up the system of the investment analysts. The return rate information acquisition unit 120 may include or obtain various information related to other investors following the corresponding investment analyst, the number of the other investment analysts, other investors followed by an investment analyst and the number of the other investment analysts.

The asset size information acquisition unit may obtain various pieces of investment asset information and investment information, such as information regarding the total amount of assets of the investment analysts, the investment items and the amount of assets invested in each item.

The asset size information acquisition unit 125 may also obtain various pieces of return rate-related information, such as the return rate of each investment portfolio proposed by the investment analysts and the overall return rate of the investment portfolios.

However, without limitations thereto, the asset size information acquisition unit 125 may comprehensively obtain a diversity of information by which the investment analysts may identify the investment and the corresponding return rate information through various financial investment systems.

According to an embodiment, obtaining the return rate information obtains information regarding the amount of investment of the investment analysts and the ROI rates for several months to several years, and rating updates the levels of the investment analysts based on the size of invested assets of the investment analysts obtained by the asset size information acquisition unit and the ROI rate information obtained from the return rate information acquisition unit.

The rating unit rates or grades the investment analyst levels with respect to the ROI rate, based on the size of invested assets of the investment analysts, obtained by the asset size information acquisition unit and the ROI rate information obtained from the return rate acquisition unit (S310).

As an example, the rating unit divides the levels of investment analysts into ion, bronze, silver, gold, platinum, diamond, master, and grand master depending on the return-on-investment rates as illustrated in FIG. 2.

According to an embodiment, the return rate information acquisition unit obtains information regarding the amount of funds invested by the members and the ROI rates for several months to several years, and the rating unit updates the levels of the investment analysts based on the ROI rate information obtained from the return rate information acquisition unit.

For example, the rating unit may obtain the investment amounts of the investment analysts and the ROI rates in units of 1-year, 3-year, and 5-year return rates and assign ratings based on the return rates obtained by the investment system.

Various changes or modifications may be made to the names and number of the ratings and a return rate reference for each rating.

Thereafter, the information providing unit displays and provides the levels of the investment analysts, which have been rated or graded according to the ROI rate information by the rating unit, to the investment information uploaded by the investment analysts according to a request (S320) for investment information from other investor (S330).

According to an embodiment, the evaluation information input unit receives evaluation information from other investors for the investment information uploaded by the investment analysts (S340).

In this case, rating updates the levels of the investment analysts by reflecting the evaluation information input to the evaluation information input unit.

Rating may include updating the investment analyst levels by reflecting the evaluation information periodically inputted to the evaluation information input unit (S350 and S360).

The evaluation information input unit secondarily receives evaluation information from other investors for the investment information uploaded by the investment analysts. For example, the evaluation information input unit 130 receives inputs of the like/dislike selection buttons from investors who have read the investment information of the investment analysts and counts the ‘like’ and ‘dislike’ inputs, respectively.

The rating unit may determine the levels of the investment analysts by further reflecting the evaluation information input to the evaluation information input unit in addition to the return rates of the investment analysts.

The rating unit updates the levels of the investment analysts by reflecting the evaluation information periodically input to the evaluation information input unit. For example, the rating unit counts the ‘like’ and ‘dislike’ inputs periodically in units of predetermined periods, e.g., after 2 days, 1 month, 6 months, and 1 year.

Accordingly, it is possible to continuously reflect the investment analysts' investment information evaluations by other investors. In other words, as the levels of the investment analysts are periodically updated, the evaluation on the investment analysis is maintained as the levels of the investment analysts, or if the evaluation by other investors gets worse over time, the levels may be lowered while the levels may be raised if the evaluation by other investors gets better. In this case, a rise of the level may occur when a predetermined number of ‘likes’ or more are received, and a fall of the level may occur when a predetermined number of ‘dislikes’ or more are received.

By periodically changing the levels of the investment analysts, the system of assessing the investment analyst levels may be more reliable.

According to an embodiment, in the method for providing investment information, receiving the evaluation information includes receiving an investment information request including the investment analyst level, filtering the investment information uploaded from investor analysts whose levels are equal to or higher than the investment analyst level, and providing the filtered information.

According to an embodiment, the information providing unit 150 receives the investment information request including the investment analyst level from the user terminal 30, filters the investment information uploaded from investor analysts whose levels are equal to or higher than the investment analyst level, and provides the filtered information. In other words, an investor may obtain only filtered investment information provided from the investment analysts whose levels are the investment analyst level or higher.

According to an embodiment, a reference for assigning ratings by the rating unit 140 is not uniformly applied to all investors.

For example, for investors who value a short-term return rate, the rating unit 140 may assign a weight of 0.8 to the return rate for 0 to 1 month and a weight of 0.2 to the return rate for 1 month to 2 years so that the investment analyst level is determined with a more weight put on the short-term return rate.

In contrast, for investors who value a long-term return rate, the rating unit 140 sets the weight for 0 to 1 month return rate to 0.1 and the weight for 1 month to 2 year return rate to 0.2. Further, the rating unit 140 may set the weight for return rate for 5 years or longer to 0.5.

Thus, a reference for rating may be set so that a higher investment analyst level is assigned to the investment analyst who produces a higher ROI rate on the items preferred by the investor or the investment analyst who produces a higher RO rate according to the investment style preferred by the investor.

According to an embodiment, the information providing unit may gather the posts or comments uploaded on the web or social media by the investment analyst whose level is the investment analyst level by web crawling and provide the same. The information providing unit 150 may also provide link information which may lead to the blog, homepage, or social media of the investor analyst's account.

In other words, the information providing unit may obtained data posted on the web by the investment analyst, but without limitations to the investment analysis information provided from the investment analyst through the investment analyst providing system.

In this case, it may be required that the investment analyst first agree to share predetermined personal information, investment analysis content, and investment analysis level.

The above-described method may be implemented as an application or in the form of program instructions executable through various computer components, which may then be recorded in a computer-readable recording medium. The computer-readable medium may include programming commands, data files, or data structures, alone or in combinations thereof.

The programming commands recorded in the computer-readable medium may be specially designed and configured for the disclosure or may be known and available to one of ordinary skill in the computer software industry.

Examples of the computer readable recording medium may include, but is not limited to, magnetic media, such as hard disks, floppy disks or magnetic tapes, optical media, such as CD-ROMs or DVDs, magneto-optical media, such as floptical disks, memories, such as ROMs, RAMs, or flash memories, or other hardware devices specially configured to retain and execute programming commands.

Examples of the programming commands may include, but are not limited to, high-level language codes executable by a computer using, e.g., an interpreter, as well as machine language codes as created by a compiler. The above-described hardware devices may be configured to operate as one or more software modules to perform processing according to the disclosure and vice versa.

While the disclosure has been shown and described with reference to exemplary embodiments thereof, it will be apparent to those of ordinary skill in the art that various changes in form and detail may be made thereto without departing from the spirit and scope of the disclosure as defined by the following claims.

What is claimed is:

1. A system for providing investment information, the system comprising:
an asset size information acquisition unit obtaining an investment asset size of an investment analyst from an investment system;
a rating unit rating an investment analyst level with respect to the investment asset size, based on the investment asset size obtained from the asset size information acquisition unit; and
an information providing unit displaying and providing the investment analyst level to investment information uploaded by the investment analyst.

2. The system of claim 1, further comprising a return rate information acquisition unit obtaining return-on-investment (ROI) rate information of the investment analyst from the investment system, wherein the rating unit rates the investment analyst level by further reflecting the ROI rate information obtained from the return rate information acquisition unit.

3. The system of claim 1, further comprising an evaluation information input unit receiving evaluation information from other investors for the investment information uploaded by the investment analyst, wherein the rating unit updates the investment analyst level by reflecting the evaluation information input to the evaluation information input unit.

4. The system of claim 3, wherein the rating unit updates the investment analyst level by reflecting the evaluation information periodically input to the evaluation information input unit.

5. The system of claim 2, wherein the return rate information acquisition unit obtains information for an investment amount of the investment analyst and an ROI rate for several months to several years for the investment amount, and wherein the rating unit updates the investment analyst level based on the ROI rate information obtained by the return rate information acquisition unit.

6. The system of claim 1, wherein the information providing unit receives an investment information request including the investment analyst level and filters investment information uploaded by investment analysts whose levels are equal to or higher than the investment analyst level and provides the filtered information.

9. A method for providing investment information, the method performed in an investment information providing system including an asset size information acquisition unit, a rating unit, and an information providing unit, the method comprising:
obtaining, by the asset size information acquisition unit, an investment asset size of an investment analyst from an investment system;
rating, by the rating unit, an investment analyst level with respect to the investment asset size, based on the investment asset size obtained from the asset size information acquisition unit; and
displaying and providing, by the information providing unit, the investment analyst level to investment information uploaded by the investment analyst according to an investment information request.

8. The method of claim 7, further comprising obtaining, by a return rate information acquisition unit, return-on-investment (ROI) rate information of the investment analyst from the investment system, wherein rating the investment analyst level includes rating the investment analyst level by further reflecting the ROI rate information obtained from the return rate information acquisition unit.

9. The method of claim 7, further comprising receiving, by an evaluation information input unit, evaluation information from other investors for the investment information uploaded by the investment analyst, wherein rating the investment analyst level includes updating the investment analyst level by reflecting the evaluation information input to the evaluation information input unit.

10. The method of claim 9, wherein rating the investment analyst level includes updating the investment analyst level by reflecting the evaluation information periodically input to the evaluation information input unit.

11. The method of claim 8, wherein obtaining the ROI rate information includes obtaining information for an investment amount of the investment analyst and an ROI rate for several months to several years for the investment amount, and wherein rating the investment analyst level includes updating the investment analyst level based on the ROI rate information obtained by the return rate information acquisition unit.

12. The method of claim 7, wherein displaying and providing the investment analyst level include receiving an investment information request including the investment analyst level and filtering investment information uploaded by investment analysts whose levels are equal to or higher than the investment analyst level and providing the filtered information.
